(19) United States
(12) Patent Application Publication
(10) Pub. No.: US 2025/0078307 A1
(43) Pub. Date: Mar. 6, 2025

(54) SYSTEMS AND METHODS FOR OBJECT DETECTION AND LOCALIZATION

(71) Applicant: Welch Allyn, Inc., Skaneateles Falls, NY (US)

(72) Inventors: David Quinn, Skaneateles Falls, NY (US); Gene J. Wolfe, Skaneateles Falls, NY (US); WonKyung McSweeney, Skaneateles Falls, NY (US)

(73) Assignee: Welch Allyn, Inc., Skaneateles Falls, NY (US)

(21) Appl. No.: 18/816,462

(22) Filed: Aug. 27, 2024

Related U.S. Application Data
(60) Provisional application No. 63/535,681, filed on Aug. 31, 2023.

(51) Int. Cl. G06T 7/70; G06F 1/16; G06V 10/22; H04W 4/029

(52) U.S. Cl. CPC G06T 7/70; G06F 1/163; G06V 10/225; H04W 4/029; G06V 2201/07

(57) ABSTRACT

An object identification system includes a processor; and a non-transitory, processor readable storage medium communicatively coupled to the processor. The non-transitory, processor readable storage medium includes one or more instructions stored thereon that, when executed, cause the processor to establish communication between an image acquisition device and a wearable device, the image acquisition device comprising a first transceiver and the wearable device including a second transceiver; receive data at the image acquisition device from the wearable device, the data including a localized position of the wearable device that is located within a field of view of the image acquisition device; and control the image acquisition device to track, based on the data, an object associated with the wearable device.

### CROSS-REFERENCE TO RELATED APPLICATIONS

This application claims priority to U.S. Provisional Patent Application Ser. No. 63/535,681, filed Aug. 31, 2023, entitled, “SYSTEMS AND METHODS FOR OBJECT DETECTION AND LOCALIZATION,” the entirety of which is incorporated by reference herein.

### FIELD

The present disclosure generally relates to object detection and localization, and more particularly, to systems and methods that detect and localize objects in a space.

### BACKGROUND

The unpredictable and continuously changing environment of a room, such as a medical surgical room, presents specific challenges to the delivery and flow of care. For example, the workflow of administering medications, monitoring, therapy, and recovery can be impacted by several factors including: user condition, such as a condition of a subject that can suddenly or unexpectedly change, which can require immediate attention and adjustments to a care plan; staff availability, such as availability of medical staff, which can impact the delivery of care; equipment, including equipment availability and functionality, can impact the delivery of care; interruptions, code blue situations such as medical emergencies or hospital-wide alerts, or equipment malfunctions, which can impact the delivery of care; communication among a medical team, the subject, and their families, which can impact the delivery of care; and user location and equipment validation and changes thereto, such as verifying if and where the subject is located in an appropriate room, verifying if the equipment is configured correctly for the subject, and verifying if the subject within the room has changed and if the corresponding equipment is appropriately configured for the changed subject. Synchronicity of these factors is critical, as is validation of the subject location.

Subjects generally wear a band that identifies them to their care staff. This band includes visible information and barcodes. Such a band can have proximity radio frequency identification (RFID) keys. However, these bands have been designed to always require an overt act by a caregiver to identify the appropriate subject.

### SUMMARY

In one aspect, an object identification system may include a processor; and a non-transitory, processor readable storage medium communicatively coupled to the processor. The non-transitory, processor readable storage medium may include one or more instructions stored thereon that, when executed, cause the processor to establish communication between an image acquisition device and a wearable device. The image acquisition device may include a first transceiver, and the wearable device may include a second transceiver. The non-transitory, processor readable storage medium may include one or more instructions stored thereon that, when executed, cause the processor to receive data at the image acquisition device from the wearable device. The data may include a localized position of the wearable device that is located within a field of view of the image acquisition device. The non-transitory, processor readable storage medium may include one or more instructions stored thereon that, when executed, cause the processor to control the image acquisition device to track, based on the data, an object associated with the wearable device.

In another aspect, a method to be performed by a processor of a computing device is provided. The method may include establishing communication between an image acquisition device including a first transceiver and a lens and a field of view, and a wearable device including a second transceiver. The method may include receiving data at the image acquisition device from the wearable device, the data including a localized position of the wearable device that is located within the field of view of the image acquisition device. The method may include controlling the image acquisition device to track, based on the data, an object associated with the wearable device.

In another aspect, a non-transitory, computer-readable medium including instructions that, when executed by at least one processor, cause the at least one processor to perform one or more operations including establishing communication between an image acquisition device including a first transceiver and a lens and a field of view, and a wearable device including a second transceiver. The instructions that, when executed by the at least one processor, cause the at least one processor to perform one or more operations including receiving data at the image acquisition device from the wearable device, the data including a localized position of the wearable device that is located within the field of view of the image acquisition device. The instructions that, when executed by the at least one processor, cause the at least one processor to perform one or more operations including controlling the image acquisition device to track, based on the data, an object associated with the wearable device.

In another aspect, an object identification system may include a processor; an image acquisition device communicatively coupled to the processor, the image acquisition device that may include a first transceiver, and a lens and a field of view; a wearable device; and a non-transitory, processor readable storage medium communicatively coupled to the processor. The non-transitory, processor readable storage medium may include one or more instructions stored thereon that, when executed, cause the processor to establish communication between the image acquisition device and the wearable device. The wearable device may include a second transceiver. The non-transitory, processor readable storage medium may include one or more instructions stored thereon that, when executed, cause the processor to receive data at the image acquisition device from the wearable device. The data may include a localized position of the wearable device that is located within the field of view of the image acquisition device. The non-transitory, processor readable storage medium may include one or more instructions stored thereon that, when executed, cause the processor to control the image acquisition device to track, based on the data, an object associated with the wearable device.

These and other features, and characteristics of the present technology, as well as the methods of operation and functions of the related elements of structure and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a schematic diagram of an example object identification system, according to one or more embodiments shown and described herein;

FIG. 2 depicts a schematic diagram of an example object identification system, according to one or more embodiments shown and described herein;

FIG. 3 depicts a schematic diagram of an example object identification system, according to one or more embodiments shown and described herein;

FIG. 4A depicts a schematic diagram of a wearable device of FIG. 1 according to one or more embodiments shown and described herein;

FIG. 4B depicts a perspective view of a circuit layout of the wearable device of FIG. 1 according to one or more embodiments shown and described herein;

FIG. 4C depicts a plan view of a circuit layout of the wearable device of FIG. 1 according to one or more embodiments shown and described herein;

FIG. 5 depicts a flow diagram of an example method to be performed by the object identification system of FIG. 1 to identify an object; and

FIG. 6 depicts a schematic diagram of an environment of the object identification system of FIGS. 1-3.

### DETAILED DESCRIPTION

The present disclosure relates to systems and methods for object detection and localization. In particular, systems and methods disclosed herein provide an object identification system that is configured to detect and track an object by communicating with a wearable device within a space such as a medical surgical room using an image acquisition device. By modifying a transmission protocol, the image acquisition device can view individual signaling patterns from individual transceivers of each wearable device. In this manner, the image acquisition device not only decodes data from the wearable device to obtain its identity but also obtains its localized position within a field of view of the image acquisition device.

While the present disclosure relates specifically to medical surgical rooms including subject monitors and hospital beds, it should be understood that this is merely an example. That is, the systems and methods described herein may be used for any type of medical equipment, including, but not limited to, overhead lifts, vital monitoring equipment, control devices, wall-mounted displays, nurses station equipment, surgical equipment, furniture, wheelchairs, and the like. Further, the systems and methods described herein may be used for non-medical equipment such as, for example, office equipment such as printers, fax machines, communications equipment, farm equipment, manufacturing equipment, and the like. In addition, while the present disclosure relates specifically to medical facilities such as hospitals, physician offices, urgent care centers, clinics, and the like, it should be understood that this is merely an example. That is, the systems and methods described herein may be located in other locations outside of medical facilities, such as offices, factories, farms, and/or the like.

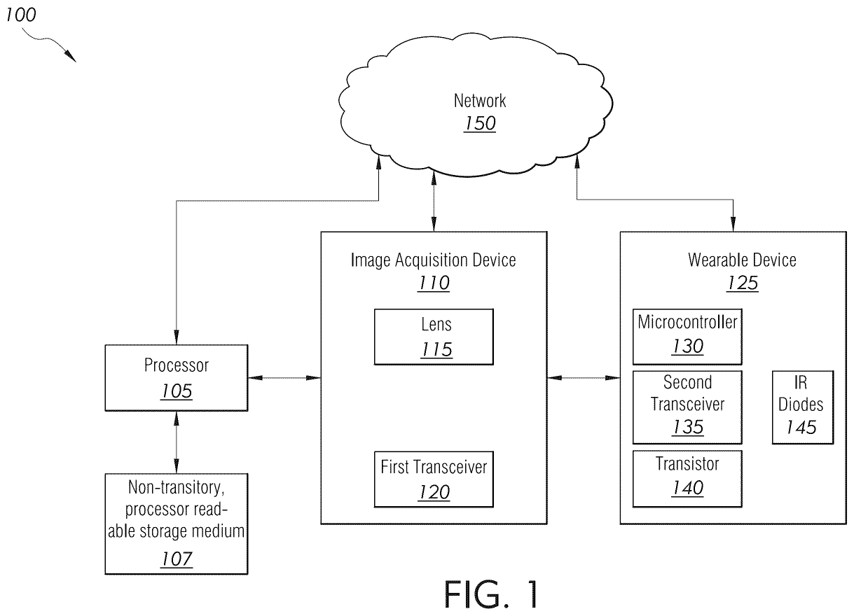

FIG. 1 depicts a schematic diagram of an object identification system 100. As illustrated in FIG. 1, the object identification system 100 includes a processor 105, a non-transitory, processor readable storage medium 107, an image acquisition device 110, a wearable device 125, and a network 150. Although FIG. 1 illustrates single instances of the constituent components of the object identification system 100, the object identification system 100 may include any number of constituent components.

The processor 105, such as a central processing unit (CPU), may be the central processing unit that is configured to perform calculations and logic operations to execute one or more programs. The processor 105, alone or in conjunction with the other components, may be an illustrative processing device, computing device, processor, or combinations thereof, including, for example, a multi-core processor, a microcontroller, a field-programmable gate array (FPGA), or an application-specific integrated circuit (ASIC). The processor 105 may include any processing component configured to receive and execute instructions (such as from the non-transitory, processor readable storage medium 107). In some embodiments, the processor 105 may include a plurality of processing devices.

The non-transitory, processor readable storage medium 107 may contain one or more data repositories for storing data that is received and/or generated. The non-transitory, processor readable storage medium 107 may be any physical storage medium, including, but not limited to, a hard disk drive (HDD), memory (e.g., read-only memory (ROM), programmable read-only memory (PROM), random access memory (RAM), double data rate (DDR) RAM, flash memory, and/or the like), removable storage, a configuration file (e.g., text) and/or the like. While the non-transitory, processor readable storage medium 107 is depicted as a local device, it should be understood that the non-transitory, processor readable storage medium 107 may be a remote storage device, such as, for example, a server computing device, cloud-based storage device, or the like.

The image acquisition device 110 includes a lens 115 and a first transceiver 120. The image acquisition device 110 includes a field of view relative to a maximum area for imaging. The first transceiver 120 includes an omnidirectional infrared transceiver. Without limitation, the image acquisition device 110 includes a video imaging camera. By way of example, the video imaging camera may include any number of: a lens, a sensor, such as imaging or IR sensors, a memory, a processor, a user interface, a display, a power source, and/or an input/output port. In some examples, the image acquisition device 110 may be controlled, for example by the processor 105, to operate in an optical band that is congruent to and operational with the wearable device 125. By way of example, the image acquisition device 110 may be configured to operate within a spectral frequency and a temporal frequency of a signaling algorithm relative to the wearable device 125.

The wearable device 125 includes a microcontroller 130, a second transceiver 135, one or more transistors 140, and one or more diodes 145. In some embodiments, the second transceiver 135 may include the first transceiver 120 of the image acquisition device 110. By way of example, and as further explained below, the wearable device 125 may include a microcontroller 130, one or more transistors 140, one or more diodes 145, one or more resistors 152, one or more capacitors 155, and a battery button 160.

The network 150 may be one or more of a wireless network, a wired network or any combination of wireless network and wired network and may be configured to connect any of the components of the object identification system 100. For example, network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 150 may include, without limitation, telephone lines, fiber optics, IEEE Ethernet 802.3, a wide area network, a wireless personal area network, a LAN, or a global network such as the Internet. In addition, network 150 may support an Internet network, a wireless communication network, a cellular network, or the like, or any combination thereof. Network 150 may further include one network, or any number of the exemplary types of networks mentioned above, operating as a stand-alone network or in cooperation with each other. Network 150 may utilize one or more protocols of one or more network elements to which they are communicatively coupled. Network 150 may translate to or from other protocols to one or more protocols of network devices. Although network 150 is depicted as a single network, it should be appreciated that according to one or more examples, network 150 may include a plurality of interconnected networks, such as, for example, the Internet, a service provider's network, a cable television network, corporate networks, such as credit card association networks, and home networks.

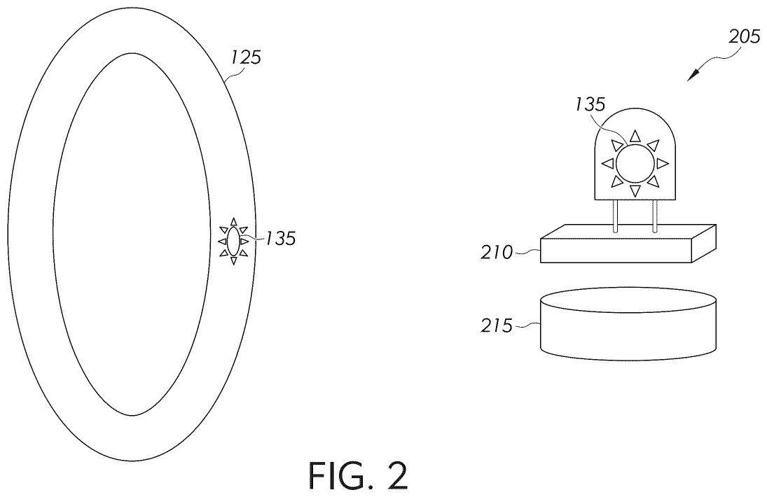

FIG. 2 depicts a schematic diagram of an object identification system 100. The object identification system 100 includes the wearable device 125, and other types of devices and equipment 205. Although FIG. 2 illustrates single instances of the constituent components of the object identification system 100, the object identification system 100 may include any number of constituent components.

The wearable device 125 may be in data communication with other types of devices and equipment 205. For example, wearable device 125 may be configured to communicate with the other types of devices and equipment 205 via respective second transceivers 135.

The other types of devices and equipment 205 may include any number and/or type of devices and equipment, such as a vital signs monitor, an IV pump, a medical bed, and the like. The other types of devices and equipment 205 may include electronics 210 and a power supply 215. The electronics 210 may include a processor, a non-transitory, processor readable storage medium, a communication interface, and a transceiver. In some examples, each of the other types of devices and equipment 205 may include a transceiver that is similar to that of the second transceiver 135. In some examples, each of the other types of devices and equipment 205 may include a transceiver that is similar to that of the first transceiver 120. The processor may be similar to that of the processor 105. The non-transitory, processor readable storage medium may be similar to that of the non-transitory, processor readable storage medium 107.

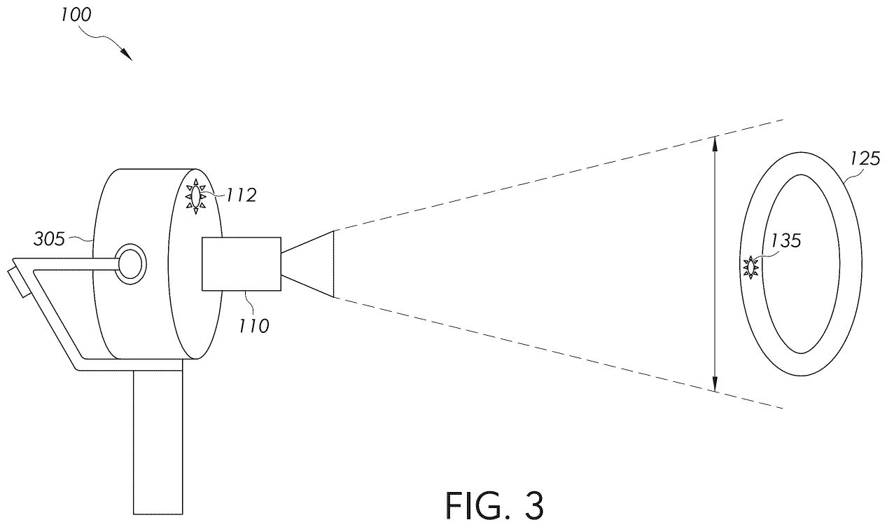

FIG. 3 depicts a schematic diagram of an object identification system 100. The object identification system 100 includes a device platform 305 and a wearable device 125. Although FIG. 3 illustrates single instances of the constituent components of the object identification system 100, the object identification system 100 may include any number of constituent components.

The device platform 305 may include a platform that is configured to house a plurality of image acquisition devices 110. Each of the plurality of image acquisition devices 110 may include a lens 115, a transceiver, such as the first transceiver 120, and an infrared (IR) transmitter 112. For example, the field of view defines an imaging area of the image acquisition device 110.

The wearable device 125 may be in data communication with any number of the plurality of image acquisition devices 110. The wearable device 125 may include a second transceiver 135. As further explained below, the second transceiver 135 may be configured to transmit a wake signal, such as via pulse code modulation or via encoded IR burst, that is periodically monitored, and demodulated or decoded, by the image acquisition device 110. The wearable device 125 may include a state machine (not shown) and include one or more modes of operation. As further discussed below, one of the one or more modes may include a standby mode. Under the standby mode of operation, the wearable device 125 may be configured to periodically emit any number of beacons, for example, every five seconds or ten seconds, the beacon indicating the presence and/or identity of the wearable device 125 and/or the subject associated with the wearable device 125. As further discussed below, one of the one or more modes may include a listening mode. Under the listening mode of operation, the wearable device 125 may be configured to listen or receive one or more input signals from the image acquisition device 120. In some examples, the wearable device 125 may be configured to implement a time-sliced algorithm for its selective operation, such that the wearable device 125 may be configured to operate as a transmitter in which it transmits a beacon for a first period of time, and operate as a receiver for a second period of time. By way of example, the wearable device 125 may be configured to operate as a transmitter for one second, and as a receiver for nine seconds. It is understood that the wearable device 125 is not limited to only these configurations and operations, and that it may include a transmitter, a receiver, or any combination thereof.

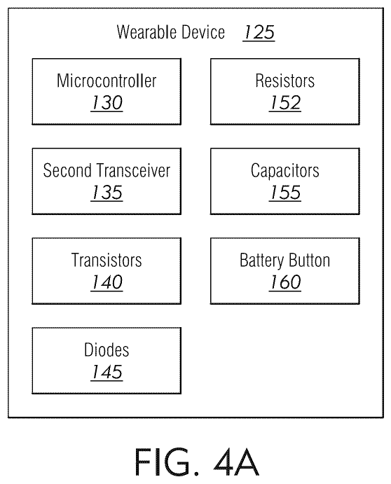

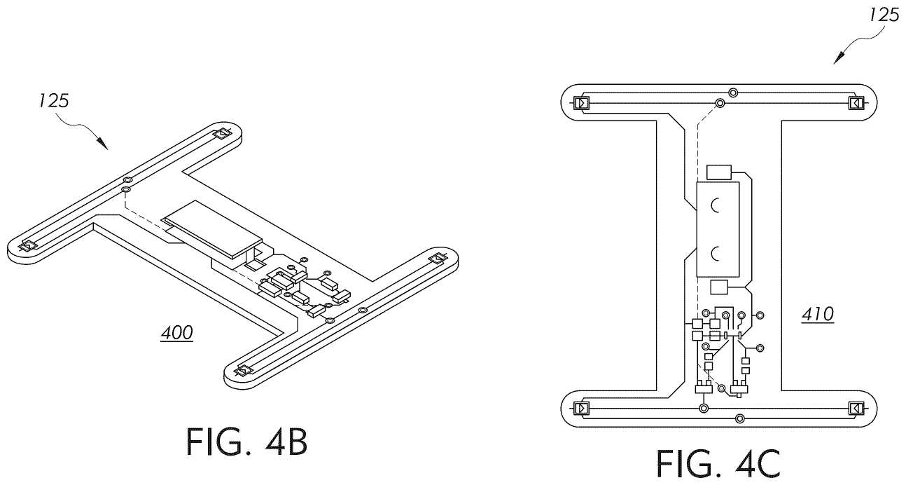

FIG. 4A depicts a schematic diagram of a wearable device 125. The wearable device 125 includes a microcontroller 130, a second transceiver 135, one or more transistors 140, one or more diodes 145, one or more resistors 152, one or more capacitors 155, and a battery button 160. As explained above, the wearable device 125 may include a transmitter, a receiver, or any combination thereof, such as the second transceiver 135 that includes the transmitter and the receiver. Without limitation, the transmitter may include an IR transmitter, and the receiver may include an IR receiver. Although FIG. 4A illustrates single instances of the constituent components of the wearable device 125, the wearable device 125 may include any number of constituent components. In some examples, the one or more transistors 140 may include one or more metal-oxide-semiconductor field-effect transistors. In some examples, the one or more diodes 145 may include one or more infrared emitting diodes. In some examples, the one or more resistors 152 may include a first resistor and a second resistor. Without limitation, the resistance of each of the first resistor and the second resistor may include ten kilo-ohms. In some examples, the one or more capacitors 155 may include a first capacitor and a second capacitor that are connected in parallel. Without limitation, at least one of the capacitors may include a capacitance of one microfarad, and the other of the capacitors may include a capacitance of ten microfarads.

FIG. 4B depicts a perspective view 400 of a circuit layout of a wearable device 125. FIG. 4C depicts a plan view 410 of a circuit layout of a wearable device 125. While the wearable device 125 is illustrated as including an I-like or I-shaped configuration, it is understood that the configuration of the wearable device 125 is not limited to such a shape. In some examples, the wearable device 125 may include of flexible material and configured to wrap around, including but not limited to, a wrist or an arm or any other body portion of a user.

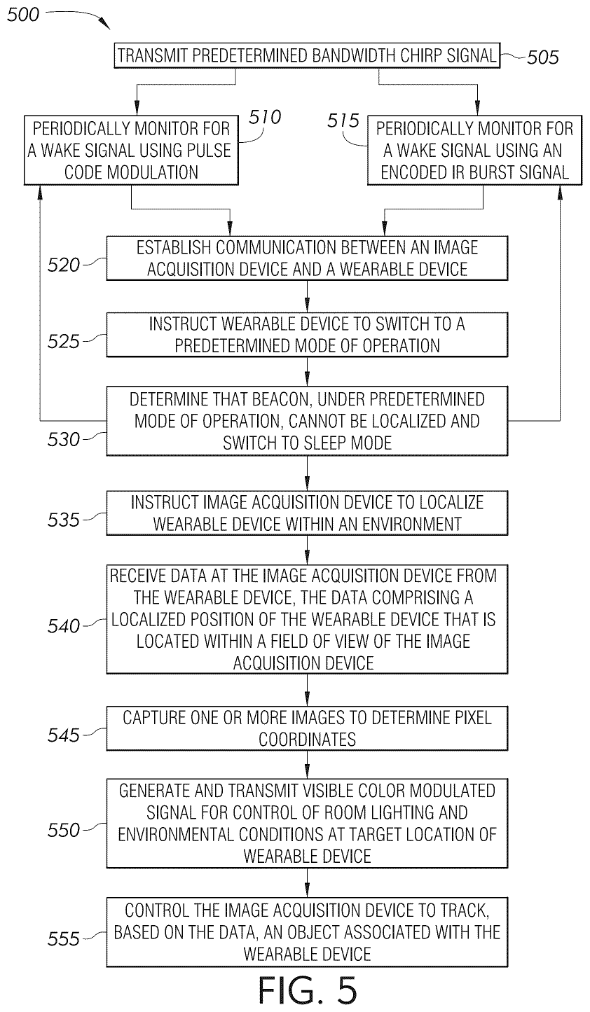

FIG. 5 depicts a flow diagram of an illustrative method 500 for identifying an object.

At block 505, the processor 105 transmits, from the image acquisition device 110, a predetermined bandwidth chirp signal to the wearable device 125. The non-transitory, processor readable storage medium 107 may include one or more instructions stored thereon that, when executed, cause the processor 105 to instruct the image acquisition device 110 transmit a predetermined bandwidth chirp signal to the wearable device 125. Upon receipt of the one or more images, the processor 105 instructs the image acquisition device 110 to perform one or more image processing operations to discern the presence of the predetermined bandwidth chirp signal. Alternatively or additionally, upon receipt of the one or more images, the processor 105 instructs the device platform 305 to perform one or more pan and scan operations that covers the environment. For example, the one or more pan and scan operations may be associated with one or more gimbal control operations to control the image acquisition device 110 to a predetermined position via a gimbal stabilizer (not shown) connected to the device platform 305, as instructed by the processor 105.

At block 510, the processor 105 instructs the image acquisition device 110 to periodically monitor for a wake signal from the wearable device 125 using pulse code modulation. The non-transitory, processor readable storage medium 107 may include one or more instructions stored thereon that, when executed, cause the processor 105 to instruct the image acquisition device 110 to periodically monitor for a wake signal from the wearable device 125 using pulse code modulation. For example, the image acquisition device 110 may be configured to use pulse code demodulation of the wake signal transmitted from the wearable device 125 to not only obtain the identifier associated with the wearable device 125 but also obtain its localized position with the field of view of the image acquisition device 110.

At block 515, the processor 105 instructs the image acquisition device 110 to periodically monitor for a wake signal from the wearable device 125 using an encoded infrared burst signal. The non-transitory, processor readable storage medium 107 may include one or more instructions stored thereon that, when executed, cause the processor 105 to instruct the image acquisition device 110 to periodically monitor for a wake signal from the wearable device 125 using an encoded infrared burst signal. For example, the image acquisition device 110 may be configured to decode the encoded infrared burst signal transmitted from the wearable device 125 to not only obtain the identifier associated with the wearable device 125 but also obtain its localized position with the field of view of the image acquisition device 110.

At block 520, communication is established between an image acquisition device 110 and a wearable device 125. For example, the image acquisition device 110 may be communicatively coupled to the processor 105. The non-transitory, processor readable storage medium 107 may include one or more instructions stored thereon that, when executed, cause the processor 105 to establish communication between the image acquisition device 110 and a wearable device 125. In some examples, the IR transmitter 112 is configured to send, as instructed by the processor 105, a continuous stream of one or more wake signals to the wearable device 125.

At block 525, the processor 105, via the image acquisition device 110, instructs the wearable device 125 to switch to a predetermined mode of operation. The non-transitory, processor readable storage medium 107 may include one or more instructions stored thereon that, when executed, cause the processor 105 to instruct the image acquisition device 110 instruct the wearable device 125 to switch to a predetermined mode of operation. In some examples, the image acquisition device 110 initiates a predetermined bandwidth chirp signal in the infrared domain that is transmitted to the wearable device 125. Upon establishing communication between the image acquisition device 110 and the wearable device 125, an instruction is transmitted from the image acquisition device 110 to the wearable device 125 to switch to a predetermined mode so as to localize the wearable device 125 within the environment. The predetermined mode of operation may include a beacon mode. Under the beacon mode of operation, the wearable device 125 transmits a beacon including, for example, an identifier associated with the wearable device 125, to the image acquisition device 110 for localization of the wearable device 125.

At block 530, the processor 105 instructs the image acquisition device 110 to: determine that a beacon, corresponding to the predetermined mode of operation, associated with the wearable device 125 cannot be localized. The processor 105 instructs the image acquisition device 110 to transmit an instruction to the wearable device 125 to deactivate the beacon. The processor 105 instructs the image acquisition device 110 to cause, based on the beacon deactivation, the wearable device 125 to switch from the predetermined mode of operation to a sleep mode of operation. The non-transitory, processor readable storage medium 107 may include one or more instructions stored thereon that, when executed, cause the processor 105 to instruct the image acquisition device 110 to determine that a beacon, corresponding to the predetermined mode of operation, associated with the wearable device 125 cannot be localized. The non-transitory, processor readable storage medium 107 may include one or more instructions stored thereon that, when executed, cause the processor 105 to instruct the image acquisition device 110 to transmit an instruction to the wearable device 125 to deactivate the beacon. The non-transitory, processor readable storage medium 107 may include one or more instructions stored thereon that, when executed, cause the processor 105 to instruct the image acquisition device 110 to cause, based on the beacon deactivation, the wearable device 125 to switch from the predetermined mode of operation to a sleep mode of operation. For example, if the beacon cannot be localized after a predetermined number of attempts, then the image acquisition device 110 transmits another instruction to deactivate the beacon mode of the wearable device 125 and enter into a sleep mode. Else, the method continues to block 535.

In other examples, the wearable device 125 initiates the predetermined bandwidth chirp signal in the infrared domain that is transmitted to the image acquisition device 110. Upon establishing communication between the image acquisition device 110 and the wearable device 125, an instruction is transmitted from the image acquisition device 110 to the wearable device 125 to switch to a predetermined mode so as to localize the wearable device 125 within the environment. The predetermined mode of operation may include a beacon mode. Under the beacon mode of operation, the wearable device 125 transmits a beacon including, for example, an identifier associated with the wearable device 125, to the image acquisition device 110 for localization of the wearable device 125. If the beacon cannot be localized after a predetermined number of attempts, then the image acquisition device 110 transmits another instruction to deactivate the beacon mode of the wearable device 125 and enter into a sleep mode. Else, the method continues to block 535.

It is understood that the systems and methods are not limited to the IR domain, and that other types of domains may be used. For example, a visible domain or a hyperspectral domain may be used.

At block 535, the processor 105 instructs the image acquisition device 110 to localize the wearable device 125 within an environment based on the predetermined mode of operation. The non-transitory, processor readable storage medium 107 may include one or more instructions stored thereon that, when executed, cause the processor 105 to instruct the image acquisition device 110 to localize the wearable device 125 within an environment based on the predetermined mode of operation.

At block 540, the image acquisition device 110 receives data from the wearable device 125. For example, the data includes a localized position of the wearable device 125 that is located within a field of view of the image acquisition device 110. The non-transitory, processor readable storage medium 107 may include one or more instructions stored thereon that, when executed, cause the processor 105 to receive data at the image acquisition device 110 from the wearable device 125. The data may include a localized position of the wearable device 125 that is located within the field of view of the image acquisition device 110. The data may further include an identifier associated with the wearable device 125. In some examples, upon receipt of the one or more wake signals from the IR transmitter 112, the wearable device 125 is configured to transmit its identifier. The image acquisition device 110 may be configured to receive the identifier from the wearable device 125.

At block 545, the processor 105 instructs the image acquisition device 110 to capture an image. The processor 105 determines the localized position of the wearable device 125 from a plurality of pixel coordinates in the image captured by the image acquisition device 110. The non-transitory, processor readable storage medium 107 may include one or more instructions stored thereon that, when executed, cause the processor 105 to instruct the image acquisition device 110 to capture one or more images, and determine the localized position from a plurality of pixel coordinates in the one or more images captured by the image acquisition device 110.

The image acquisition device 110 is configured to transmit the one or more images to the processor 105. The processor 105 is configured to execute one or more instructions relative to the one or more images. For example, the processor 105 is configured to identify, from the one or more images, one or more entities that represent a user within the field of view of the image acquisition device 110. For each of the one or more entities, the processor 105 is configured to generate a pose estimation that includes a skeletal representation and a plurality of positions of the object in a three-dimensional space within the environment. For example, the plurality of positions may include, without limitation, a knee joint, an arm joint, an elbow joint, a wrist joint, and an ankle joint. The processor 105 is configured to produce a three-dimensional point in the three-dimensional space that represents the location of the object within the environment. The processor 105 is configured to instruct the device platform 305, including any number of image acquisition devices 110, to move to the location of the object within the environment.

The image acquisition device 110, including the lens 115 and a field of view, is located within the environment. Based on a plurality of pixel coordinates in the image, the location of the wearable device 125 may be obtained by the processor 105. The distance to a point source, such as the wearable device 125, is computed by the processor 105 as an ideal point spread function measurement. The processor 105 is configured to obtain an illumination source spot size, which may be measured as a value in square millimeters, and a pixel pitch of the one or more images, which may be measured as a value in microns. The illumination source spot size and pixel pitch of the one or more images, in conjunction with a value indicative of a lens focal distance of the image acquisition device 110 and a value of the aperture size are taken into account for obtaining the location of the wearable device by the processor 105.

At block 550, the processor 105 instructs the image acquisition device 110 to receive a visible color modulated signal from the wearable device 125. The processor 105 instructs the image acquisition device 110 to generate, based on the visible color modulated signal, a compensation model for room lighting at a target location of wearable device 125. The non-transitory, processor readable storage medium 107 may include one or more instructions stored thereon that, when executed, cause the image acquisition device 110 to receive a visible color modulated signal from the wearable device 125. The non-transitory, processor readable storage medium 107 may include one or more instructions stored thereon that, when executed, cause the image acquisition device 110 to generate, based on the visible color modulated signal, a compensation model for room lighting at a target location of the wearable device 125.

The wearable device 125 may include an emitter that is configured to generate and transmit a visible color modulated signal to the image acquisition device 110. By way of example, the emitter may include one or more diodes 145, such as one or more of red, green, blue, and white (RGBW) light emitting diodes (LEDs), a RGBW+IR LEDs, or any combination thereof. The processor 105 is configured to control each distinct color of the one or more diodes 145 and may be treated as a symbol token, such as a data stream component (including a character in a data packet), which may be used in combination with a color imager of the image acquisition device 110 to achieve a higher effective data rate. For example, an individual LED diode may represent a specific communication channel. By individually signaling each color as an individual communication channel, a multiplier of the original data rate can be achieved. For example, using an RGBW+IR LED, fives times the original data rate may be obtained due to RGBW as well as IR for the LED. Error checking and correction algorithms may be implemented for data packet bits, such as using cycling redundancy check (CRC) or Hamming code.

The wearable device 125 is configured to, either by instruction from the image acquisition device 110 and/or periodically on its own, transmit a visible color pattern of known duration and sequence to the image acquisition device 110. Upon receipt of this information, the image acquisition device 110 captures the visible color pattern of known duration and sequence. The image acquisition device 110 performs, based on a-priori information about the spectral density of the one or more diodes 145, one or more operations on the one or more images to generate a color and gain compensation model for control of room lighting and environmental conditions at a target location of the wearable device 125. This calibration by the image acquisition device 110 allows it to achieve a precise gain, color, and ambient lighting corrections, including but not limited to generating a more precise color image for rash, would, and/or blood flow analysis by the processor 105.

At block 555, the processor 105 controls the image acquisition device 110 to track, based on the data, an object associated with the wearable device 125. The non-transitory, processor readable storage medium 107 may include one or more instructions stored thereon that, when executed, cause the processor 105 to control the image acquisition device 110 to track, based on the data, an object associated with the wearable device 125. Without limitation, the object may include a user, such as a subject. The processor 105 instructs the image acquisition device 110 to optimally target the user being monitored, based on the identifier and image acquisition device data. In some examples, the image acquisition device data may include pitch and angle data of the image acquisition device 110.

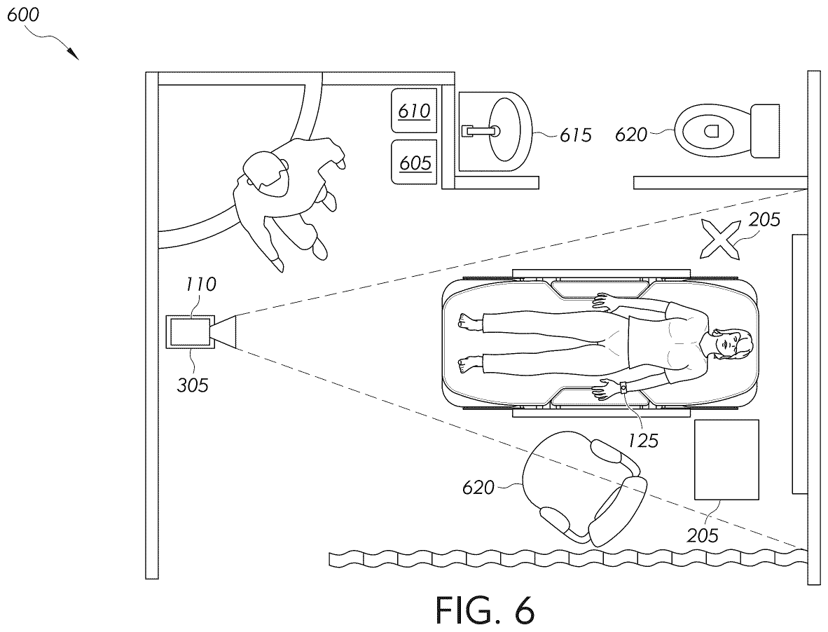

FIG. 6 schematically depicts an example environment 600 using the systems and methods disclosed herein. The environment 600 includes a device platform 305, an image acquisition device 110, an object associated with a wearable device 125, and other types of devices and equipment 205. The other types of devices and equipment 205 may include an IV pump. The environment 600 further includes a linen compartment 605, a trash compartment 610, a sink 615, a toilet 620, and a chair 625.

As a non-limiting example of the systems and methods described above, the processor 105 is configured to determine that a subject is on a bed in an operating room, in a prone body posture, that a wearable device 125 is within a field of view of the image acquisition device 110, and that certain colors of the one or more diodes 145 of the wearable device 125 are illuminated.

As another non-limiting example of the systems and methods described above, the processor 105 is configured to determine that a subject is on a chair or bed in a subject room, in a supine body posture, that a wearable device 125 is within a field of view of the image acquisition device 110, and that certain colors of the one or more diodes 145 of the wearable device 125 are illuminated.

In either of these non-limiting examples, each of the colors of the one or more diodes 145 of the wearable device 125 that are illuminated may indicate a respective entry area and/or exit area relative to the environment 600, such as an area that alerts via a red color the subject is prohibited from going to, and/or an area that alerts via a green color the subject is approaching an exit location. Moreover, each of the colors of the one or more diodes 145 of the wearable device 125 that are illuminated may be continuously flashed for a predetermined period of time, or periodically flashed for a predetermined period of time, or any combination thereof.

The present disclosure relates to systems and methods for object detection and localization. In particular, systems and methods disclosed herein provide an object identification system that is configured to detect and track an object by communicating with a wearable device within a space such as a medical surgical room using an image acquisition device. Subjects that have a band, which have been designed to always require an overt act by a caregiver to identify them, generally include visible information and barcodes and RFID keys. In contrast, by modifying a transmission protocol, the image acquisition device can view individual signaling patterns from individual transceivers of each wearable device. In this manner, the image acquisition device not only decodes data from the wearable device to obtain its identity but also obtains its localized position within a field of view of the image acquisition device.

Further aspects of the invention are provided by the subject matter of the following clauses.

An object identification system, including: a processor; and a non-transitory, processor readable storage medium communicatively coupled to the processor, the non-transitory, processor readable storage medium including one or more instructions stored thereon that, when executed, cause the processor to: establish communication between an image acquisition device and a wearable device, the image acquisition device including a first transceiver and the wearable device including a second transceiver; receive data at the image acquisition device from the wearable device, the data including a localized position of the wearable device that is located within a field of view of the image acquisition device; and control the image acquisition device to track, based on the data, an object associated with the wearable device.

The object identification system of any preceding clause, wherein the data further includes an identifier associated with the wearable device.

The object identification system of any preceding clause, wherein the one or more instructions further cause the processor to instruct the image acquisition device to capture an image, and determine the localized position from a plurality of pixel coordinates in the image captured by the image acquisition device.

The object identification system of any preceding clause, wherein the one or more instructions further cause the processor to instruct the image acquisition device to transmit a predetermined bandwidth chirp signal to the wearable device.

The object identification system of any preceding clause, wherein the one or more instructions further cause the processor to instruct the image acquisition device to instruct the wearable device to switch to a predetermined mode of operation.

The object identification system of any preceding clause, wherein the one or more instructions further cause the processor to instruct the image acquisition device to localize the wearable device within an environment based on the predetermined mode of operation.

The object identification system of the preceding clause, wherein the one or more instructions further cause the processor to instruct the image acquisition device to: determine that a beacon, corresponding to the predetermined mode of operation, associated with the wearable device cannot be localized; transmit an instruction to the wearable device to deactivate the beacon; and cause, based on the beacon deactivation, the wearable device to switch from the predetermined mode of operation to a sleep mode of operation.

The object identification system of any preceding clause, wherein the one or more instructions further cause the processor to instruct the image acquisition device to periodically monitor for a wake signal from the wearable device using pulse code modulation.

The object identification system of any preceding clause, wherein the one or more instructions further cause the processor to instruct the image acquisition device to periodically monitor for a wake signal from the wearable device using an encoded infrared burst signal.

The object identification system of any preceding clause, wherein the one or more instructions further cause the image acquisition device to: receive a visible color modulated signal from the wearable device; and generate, based on the visible color modulated signal, a compensation model for room lighting at a target location of the wearable device.

A method for identifying an object, the method including: establishing communication between an image acquisition device including a first transceiver and a lens and a field of view, and a wearable device including a second transceiver; receiving data at the image acquisition device from the wearable device, the data including a localized position of the wearable device that is located within the field of view of the image acquisition device; and controlling the image acquisition device to track, based on the data, an object associated with the wearable device.

The method of any preceding clause, wherein the data further includes an identifier associated with the wearable device.

The method of any preceding clause, further including: instructing the image acquisition device to capture an image; and determining the localized position from a plurality of pixel coordinates in the image captured by the image acquisition device.

The method of any preceding clause, further including transmitting, from the image acquisition device, a predetermined bandwidth chirp signal to the wearable device.

The method of any preceding clause, further including instructing the wearable device to switch to a predetermined mode of operation.

The method of any preceding clause, further including instructing the image acquisition device to localize the wearable device within an environment based on the predetermined mode of operation.

The method of any preceding clause, further including instructing the image acquisition device to: determine that a beacon, corresponding to the predetermined mode of operation, associated with the wearable device cannot be localized; transmit an instruction to the wearable device to deactivate the beacon; and cause, based on the beacon deactivation, the wearable device to switch from the predetermined mode of operation to a sleep mode of operation.

The method of any preceding clause, further including instructing the image acquisition device to periodically monitor for a wake signal from the wearable device using pulse code modulation.

The method of any preceding clause, further including instructing the image acquisition device to periodically monitor for a wake signal from the wearable device using an encoded infrared burst signal.

The method of any preceding clause, further including instructing the image acquisition device to: receive a visible color modulated signal from the wearable device; and generate, based on the visible color modulated signal, a compensation model for room lighting at a target location of wearable device.

A non-transitory, computer-readable medium including instructions that, when executed by at least one processor, cause the at least one processor to perform one or more operations including: establishing communication between an image acquisition device including a first transceiver and a lens and a field of view, and a wearable device including a second transceiver; receiving data at the image acquisition device from the wearable device, the data including a localized position of the wearable device that is located within the field of view of the image acquisition device; and controlling the image acquisition device to track, based on the data, an object associated with the wearable device.

The non-transitory, computer-readable medium of any preceding clause, wherein the data further includes an identifier associated with the wearable device.

The non-transitory, computer-readable medium of any preceding clause, the one or more operations further including: instructing the image acquisition device to capture an image; and determining the localized position from a plurality of pixel coordinates in the image captured by the image acquisition device.

The non-transitory, computer-readable medium of any preceding clause, the one or more operations further including transmitting, from the image acquisition device, a predetermined bandwidth chirp signal to the wearable device.

The non-transitory, computer-readable medium of any preceding clause, the one or more operations further including instructing the wearable device to switch to a predetermined mode of operation.

The non-transitory, computer-readable medium of any preceding clause, the one or more operations further including instructing the image acquisition device to localize the wearable device within an environment based on the predetermined mode of operation.

The non-transitory, computer-readable medium of any preceding clause, the one or more operations further including instructing the image acquisition device to: determine that a beacon, corresponding to the predetermined mode of operation, associated with the wearable device cannot be localized; transmit an instruction to the wearable device to deactivate the beacon; and cause, based on the beacon deactivation, the wearable device to switch from the predetermined mode of operation to a sleep mode of operation.

The non-transitory, computer-readable medium of any preceding clause, the one or more operations further including instructing the image acquisition device to periodically monitor for a wake signal from the wearable device using pulse code modulation.

The non-transitory, computer-readable medium of any preceding clause, the one or more operations further including instructing the image acquisition device to periodically monitor for a wake signal from the wearable device using an encoded infrared burst signal.

The non-transitory, computer-readable medium of any preceding clause, the one or more operations further including instructing the image acquisition device to: receive a visible color modulated signal from the wearable device; and generate, based on the visible color modulated signal, a compensation model for room lighting at a target location of wearable device.

An object identification system, including: a processor; an image acquisition device communicatively coupled to the processor, the image acquisition device including a first transceiver, and a lens and a field of view; a wearable device; and a non-transitory, processor readable storage medium communicatively coupled to the processor, the non-transitory, processor readable storage medium including one or more instructions stored thereon that, when executed, cause the processor to: establish communication between the image acquisition device and the wearable device, the wearable device including a second transceiver; receive data at the image acquisition device from the wearable device, the data including a localized position of the wearable device that is located within the field of view of the image acquisition device; and control the image acquisition device to track, based on the data, an object associated with the wearable device.

The object identification system of any preceding clause, wherein the data further includes an identifier associated with the wearable device.

The object identification system of any preceding clause, wherein the one or more instructions further cause the processor to: instruct the image acquisition device to capture an image, and determine the localized position from a plurality of pixel coordinates in the image captured by the image acquisition device.

The object identification system of any preceding clause, wherein the one or more instructions further cause the processor to instruct the image acquisition device to transmit a predetermined bandwidth chirp signal to the wearable device.

The object identification system of any preceding clause, wherein the one or more instructions further cause the processor to instruct the image acquisition device to instruct the wearable device to switch to a predetermined mode of operation.

The object identification system of any preceding clause, wherein the one or more instructions further cause the processor to instruct the image acquisition device to localize the wearable device within an environment based on the predetermined mode of operation.

The object identification system of any preceding clause, wherein the one or more instructions further cause the processor to instruct the image acquisition device to: determine that a beacon, corresponding to the predetermined mode of operation, associated with the wearable device cannot be localized; transmit an instruction to the wearable device to deactivate the beacon; and cause, based on the beacon deactivation, the wearable device to switch from the predetermined mode of operation to a sleep mode of operation.

The object identification system of any preceding clause, wherein the one or more instructions further cause the processor to instruct the image acquisition device to periodically monitor for a wake signal from the wearable device using pulse code modulation.

The object identification system of any preceding clause, wherein the one or more instructions further cause the processor to instruct the image acquisition device to periodically monitor for a wake signal from the wearable device using an encoded infrared burst signal.

The object identification system of any preceding clause, wherein the one or more instructions further cause the image acquisition device to: receive a visible color modulated signal from the wearable device; and generate, based on the visible color modulated signal, a compensation model for room lighting at a target location of the wearable device.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein include one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An object identification system, comprising:
a processor; and
a non-transitory, processor readable storage medium communicatively coupled to the processor, the non-transitory, processor readable storage medium comprising one or more instructions stored thereon that, when executed, cause the processor to:
establish communication between an image acquisition device and a wearable device, the image acquisition device comprising a first transceiver and the wearable device comprising a second transceiver;
receive data at the image acquisition device from the wearable device, the data comprising a localized position of the wearable device that is located within a field of view of the image acquisition device; and
control the image acquisition device to track, based on the data, an object associated with the wearable device.

2. The object identification system of claim 1, wherein the data further comprises an identifier associated with the wearable device.

3. The object identification system of claim 1, wherein the one or more instructions further cause the processor to instruct the image acquisition device to capture an image, and determine the localized position from a plurality of pixel coordinates in the image captured by the image acquisition device.

4. The object identification system of claim 1, wherein the one or more instructions further cause the processor to instruct the image acquisition device to transmit a predetermined bandwidth chirp signal to the wearable device.

5. The object identification system of claim 1, wherein the one or more instructions further cause the processor to instruct the image acquisition device to instruct the wearable device to switch to a predetermined mode of operation.

6. The object identification system of claim 5, wherein the one or more instructions further cause the processor to instruct the image acquisition device to localize the wearable device within an environment based on the predetermined mode of operation.

7. The object identification system of claim 5, wherein the one or more instructions further cause the processor to instruct the image acquisition device to:
determine that a beacon, corresponding to the predetermined mode of operation, associated with the wearable device cannot be localized;
transmit an instruction to the wearable device to deactivate the beacon; and
cause, based on the beacon deactivation, the wearable device to switch from the predetermined mode of operation to a sleep mode of operation.

8. The object identification system of claim 1, wherein the one or more instructions further cause the processor to instruct the image acquisition device to periodically monitor for a wake signal from the wearable device using pulse code modulation.

9. The object identification system of claim 1, wherein the one or more instructions further cause the processor to instruct the image acquisition device to periodically monitor for a wake signal from the wearable device using an encoded infrared burst signal.

10. The object identification system of claim 1, wherein the one or more instructions further cause the image acquisition device to:
receive a visible color modulated signal from the wearable device; and
generate, based on the visible color modulated signal, a compensation model for room lighting at a target location of the wearable device.

11. A method for identifying an object, the method comprising:
establishing communication between an image acquisition device comprising a first transceiver and a lens and a field of view, and a wearable device including a second transceiver;
receiving data at the image acquisition device from the wearable device, the data comprising a localized position of the wearable device that is located within the field of view of the image acquisition device; and
controlling the image acquisition device to track, based on the data, an object associated with the wearable device.

12. The method of claim 11, wherein the data further comprises an identifier associated with the wearable device.

13. The method of claim 11, further comprising:
instructing the image acquisition device to capture an image; and
determining the localized position from a plurality of pixel coordinates in the image captured by the image acquisition device.

14. The method of claim 11, further comprising transmitting, from the image acquisition device, a predetermined bandwidth chirp signal to the wearable device.

15. The method of claim 11, further comprising instructing the wearable device to switch to a predetermined mode of operation.

16. The method of claim 15, further comprising instructing the image acquisition device to localize the wearable device within an environment based on the predetermined mode of operation.

17. The method of claim 15, further comprising instructing the image acquisition device to:
determine that a beacon, corresponding to the predetermined mode of operation, associated with the wearable device cannot be localized;
transmit an instruction to the wearable device to deactivate the beacon; and
cause, based on the beacon deactivation, the wearable device to switch from the predetermined mode of operation to a sleep mode of operation.

18. The method of claim 11, further comprising instructing the image acquisition device to periodically monitor for a wake signal from the wearable device using pulse code modulation.

19. The method of any claim 11, further comprising instructing the image acquisition device to:
receive a visible color modulated signal from the wearable device; and
generate, based on the visible color modulated signal, a compensation model for room lighting at a target location of wearable device.

20. A non-transitory, computer-readable medium comprising instructions that, when executed by at least one processor, cause the at least one processor to perform one or more operations comprising:
establishing communication between an image acquisition device comprising a first transceiver and a lens and a field of view, and a wearable device including a second transceiver;
receiving data at the image acquisition device from the wearable device, the data comprising a localized position of the wearable device that is located within the field of view of the image acquisition device; and
controlling the image acquisition device to track, based on the data, an object associated with the wearable device.
